(19) United States
(12) Patent Application Publication
(10) Pub. No.: US 2005/0151015 A1
(43) Pub. Date: Jul. 14, 2005

(54) Adaptive composite skin technology (ACTS)

(75) Inventors: Christopher M. Cagle, Yorktown, VA (US); Robin W. Schlecht, Newport News, VA (US)

Correspondence Address: NATIONAL AERONAUTICS AND SPACE ADMINISTR;ATION LANGLEY RESEARCH CENTER, 3 LANGLEY BOULEVARD, MAIL STOP 212, HAMPTON, VA, 236812199, US

(73) Assignee: United States of America as represented by the Administrator of the NASA, Washington, DC (US)

(21) Appl. No.: 10/828,528

(22) Filed: Apr. 9, 2004

Related U.S. Application Data
(60) Provisional application No. 60/461,563, filed on Apr. 9, 2003.

(51) Int. Cl. B64C 1/00

(52) U.S. Cl. 244/123; 244/130

(57) ABSTRACT

A tailorable elastic skin is provided for covering shape-changing, or “morphable,” structures. The skin comprises a two-dimensional “planar spring” embedded in an elastomeric material. The invention provides a smooth aerodynamic covering capable of global elongation exceeding 20% with a low input force. The design can be tailored for light-weight, lightly loaded applications, or for more heavily loaded aerodynamic or hydrodynamic conditions.

This application claims the benefit of U.S. Provisional Application No. 60/461,563, filed Apr. 9, 2003, and entitled “Adaptive Composite Skin Technology (ACTS).”

### BACKGROUND OF THE INVENTION

1. Field of the Invention

The subject invention relates to aerodynamic skin material, and relates more specifically to tailorable adaptive, elastic composite skins for aerodynamic or hydrodynamic applications.

2. Description of the Related Art

Many of the proposals for aircraft that can perform large aerodynamic shape change require a flexible skin that can follow the change of some internal structure, which can be driven by conventional actuators, or possibly by “smart” actuators. These shape changes can be in the form of large bumps, conformal wing changes of platform, camber, twist, sweep, anhedral/dihedral, and integrated leading and trailing edge flaps or other devices. Presently no method exists to provide a smooth aerodynamic surface capable of large deflections while maintaining smoothness and rigidity. The only materials that come close to providing a smooth covering are latex or silicone rubber type materials, but for the required out-of-plane stiffness they require a thick section and excessive driving force.

Some prior art systems exist comprising skeletal frameworks, or structural frameworks laminated within elastomeric sheets. U.S. Pat. No. 6,588,709 by Dunne discloses a flexible skin formed by enveloping shape memory alloy rods, but does not provide the structure or capabilities offered by the present subject invention. U.S. Pat. No. 6,027,074—to Cameron discloses a reinforced elastomeric panel with rigid members and removable plate, but nothing resembling a planar spring. U.S. Pat. No. 6,337,294 to Waldrop discloses an elastic ground plane without spring qualities, and using an elastomer only for grounding purposes. Three patents to Geiger (U.S. Pat. Nos. 5,810,291, 5,931,422, and 5,958,803) disclose a variety of structurally reinforced elastomeric panels, but without planar spring structure or function. U.S. Pat. No. 4,038,040 to Nagl discloses an etched lattice grid structure which provides the capability of being formed into a geometry of compound curvature. Nagl does not, however, disclose a planar spring skeletal structure or an elastomeric component. U.S. Pat. No. 5,962,150 to Priluck similarly discloses a structural lattice configuration, but a rigid one, and one without an elastomeric component.

Generally speaking, prior art exists that discloses structurally reinforced elastomers, or lattice-like structural systems. No system exists, however, which satisfactorily provides a flexible, elastic skin, capable of significant deflection, while maintaining smoothness and rigidity, suitable for use with aerodynamic vehicles and watercraft.

### BRIEF SUMMARY OF THE INVENTION

Accordingly, it is an object of the present invention to provide a flexible skin for use on aircraft and watercraft.

It is another object of the present invention to provide a flexible skin capable of large deflection while maintaining smoothness and rigidity.

It is yet another object of the present invention to provide a flexible skin that enables the real-time alteration of aircraft or watercraft external geometry.

The present invention is a tailorable, adaptive, elastic composite skin that accomplishes the objects above. These and other objects will become more readily appreciated and understood from a consideration of the following detailed description of the invention, when taken together with the accompanying drawings.

The preferred embodiment of the invention comprises at least one skeletal bi-directional spring, embedded within a flexible, preferably elastomeric, solid. The best mode of the invention varies considerably by the intended application and by the required mechanical properties of the composite skin. Although each embodiment of the present invention comprises at least one skeletal component and at least one elastomeric element, specifically selected materials, properties, and manufacturing processes may vary considerably to suit the intended use for the composite skin. The following detailed description will provide instruction on how the preferred embodiment may be modified to suit specific intended applications of the invention.

### BRIEF DESCRIPTION OF THE SEVERAL VIEWS OF THE DRAWINGS

FIGS. 1-40 are two-dimensional representations of embodiments considered for the reinforcement skeleton (i.e. planar or bidirectional spring) for the present invention.

FIG. 41 is a depiction of a Computer Aided Design model of a planar spring with flexibility in one direction.

FIG. 42 is a depiction of a Computer Aided Design model of a planar spring with flexibility in two directions.

### DETAILED DESCRIPTION OF THE INVENTION

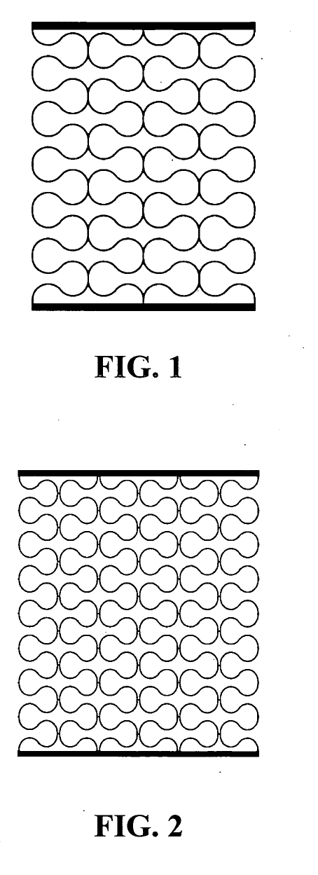

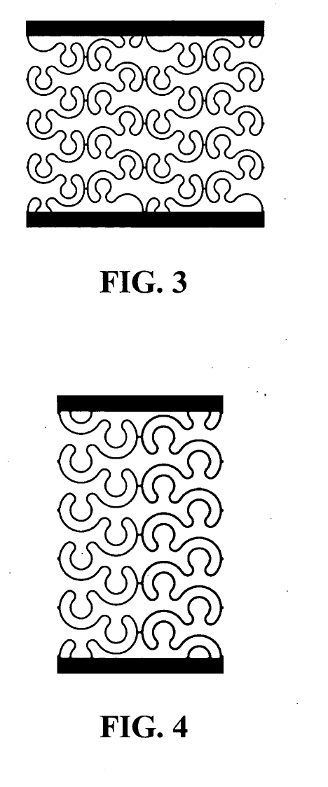

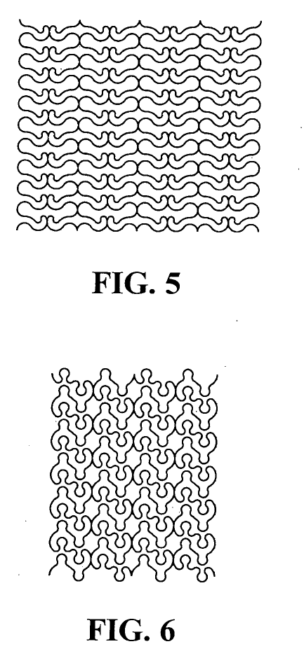

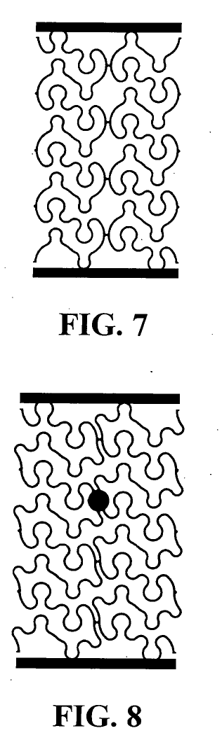

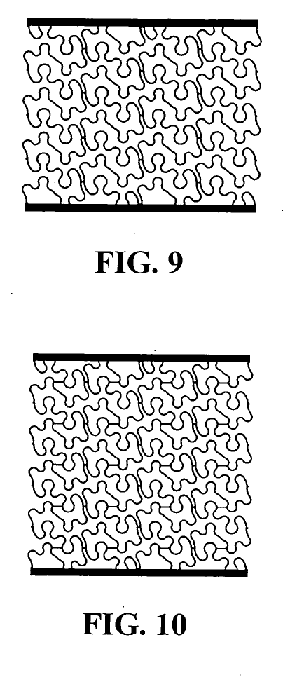

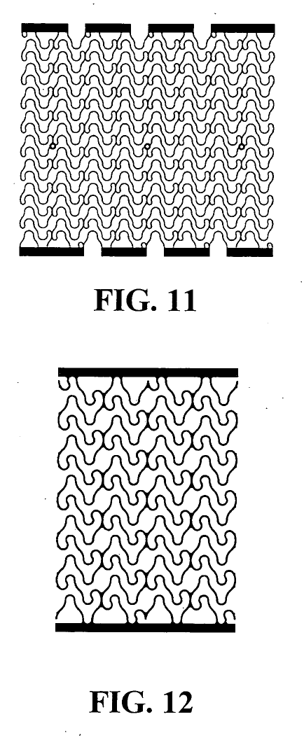

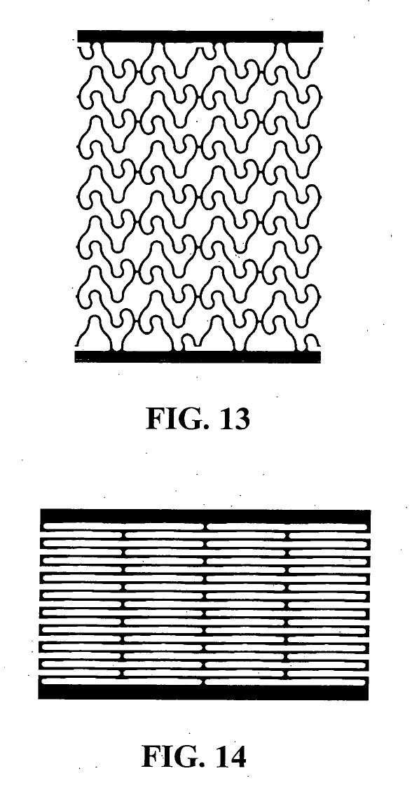

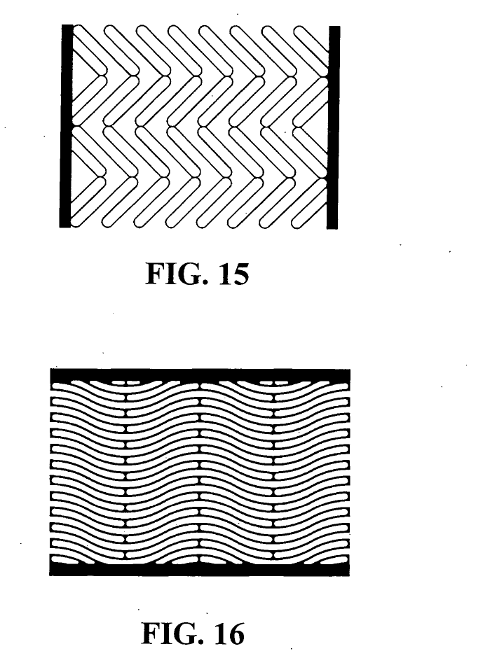

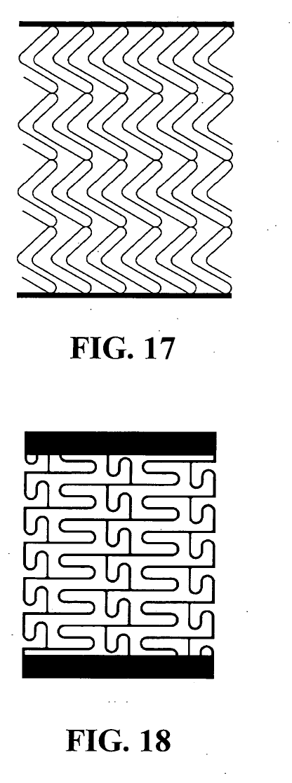

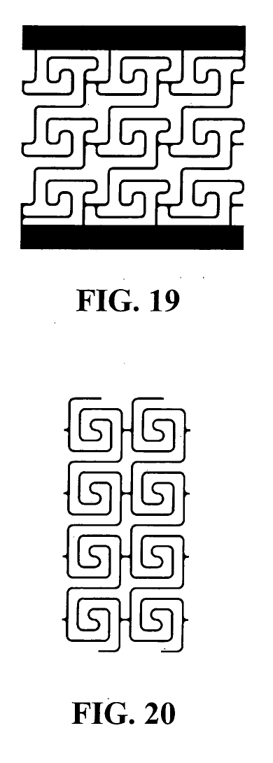

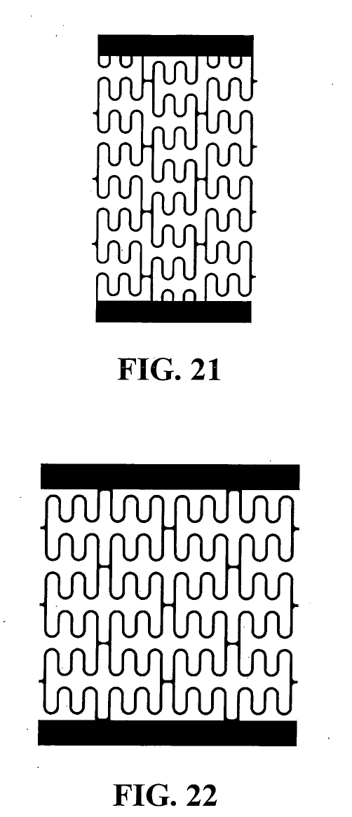

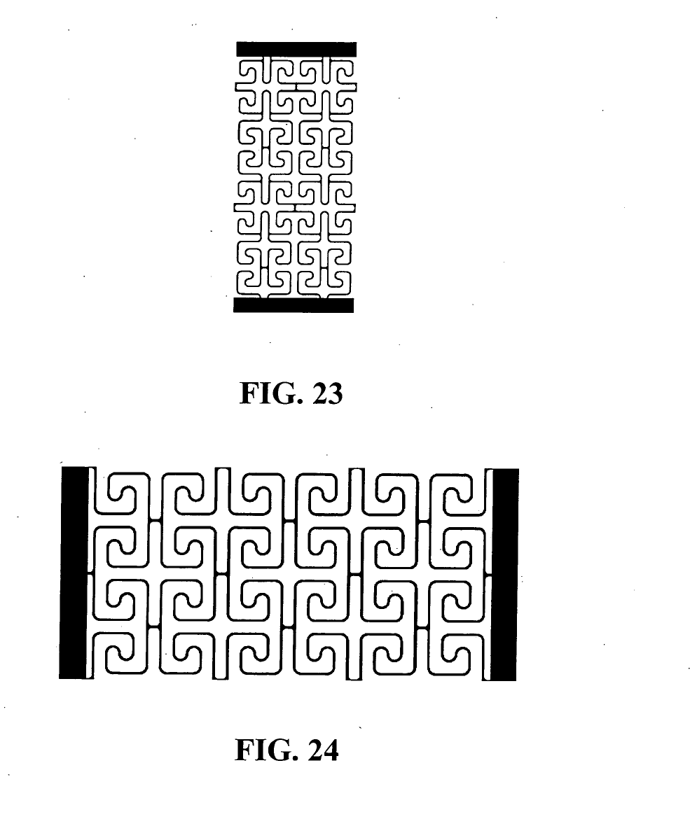

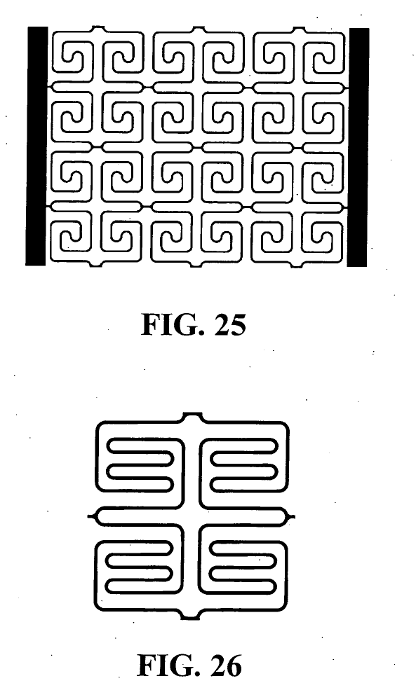

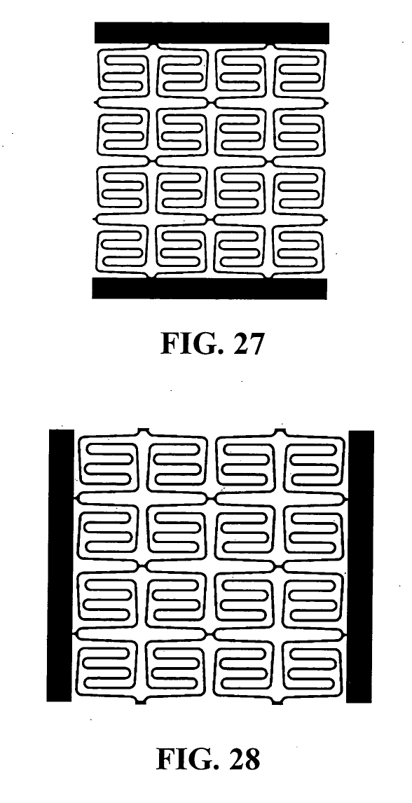

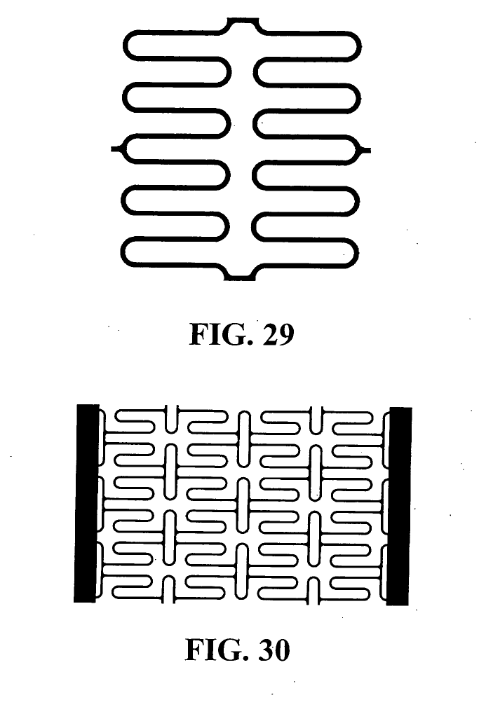

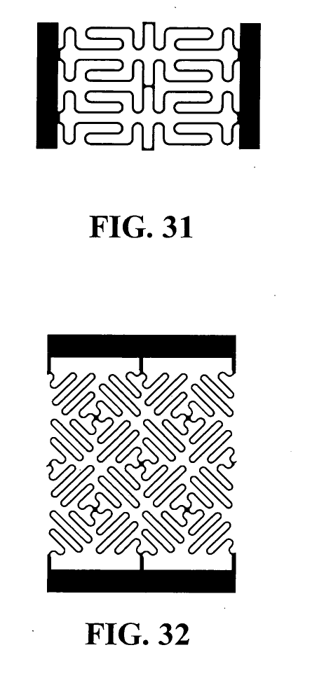

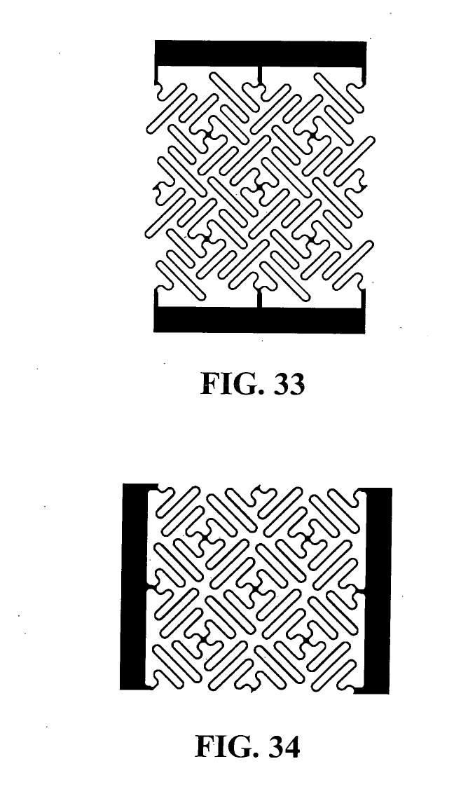

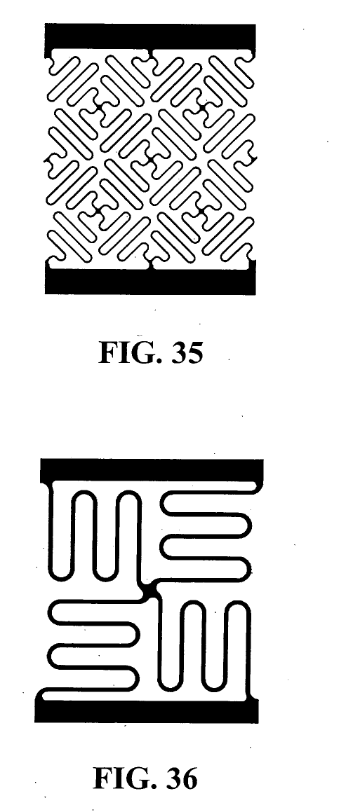

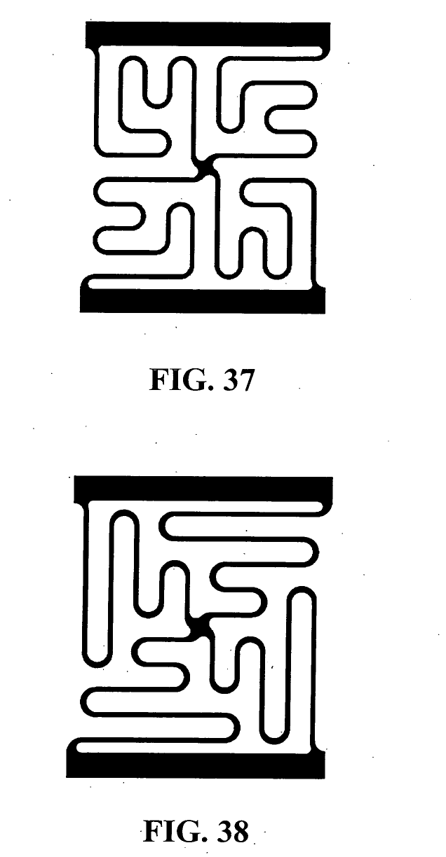

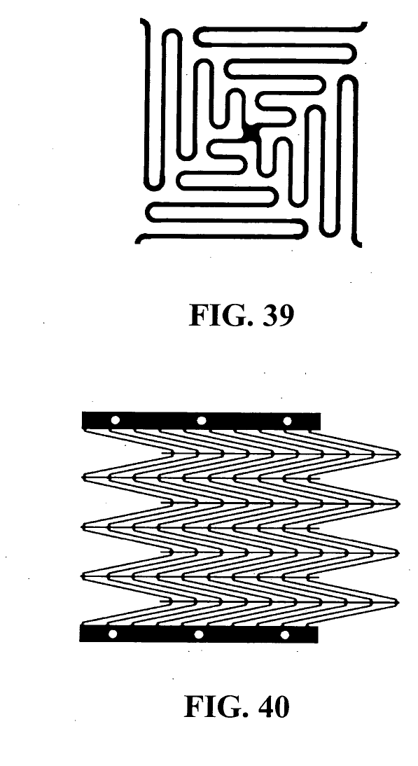

The present invention is a flexible skin, which smoothly “wraps” a structural shape, with low actuation force required to stretch or warp the surface. The skin assembly consists of a relatively stiff internal skeleton, made of metallic or possibly plastic/composite material. Visual examples of internal skeleton geometry are provided in FIGS. 1-40.

One embodiment of the present invention consists of multiple layers of flexible components, including at least one internal skeleton. A first step in producing the internal skeleton is to develop the geometry of a single element of a full 2-D planar spring design that visually appears to have suitable mechanical properties, depending on the type and direction of in-plane deflection desired. Global elongation is driven by the beam bending properties of the members of the planar spring. At one extreme is a 1-dimensional spring that is very flexible in one direction and completely stiff in the orthogonal direction. Many requirements alternatively call for similar flexibility in all directions.

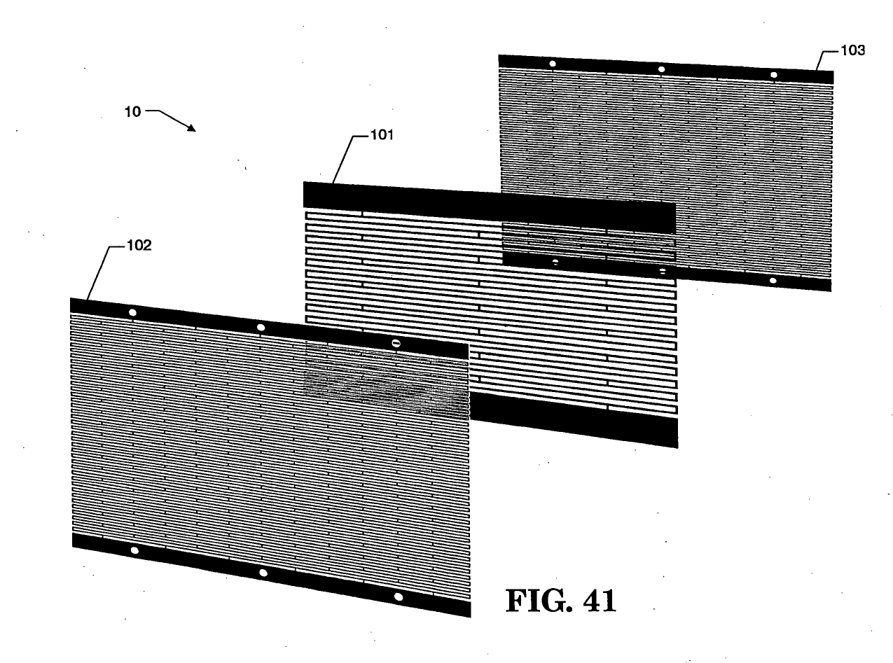

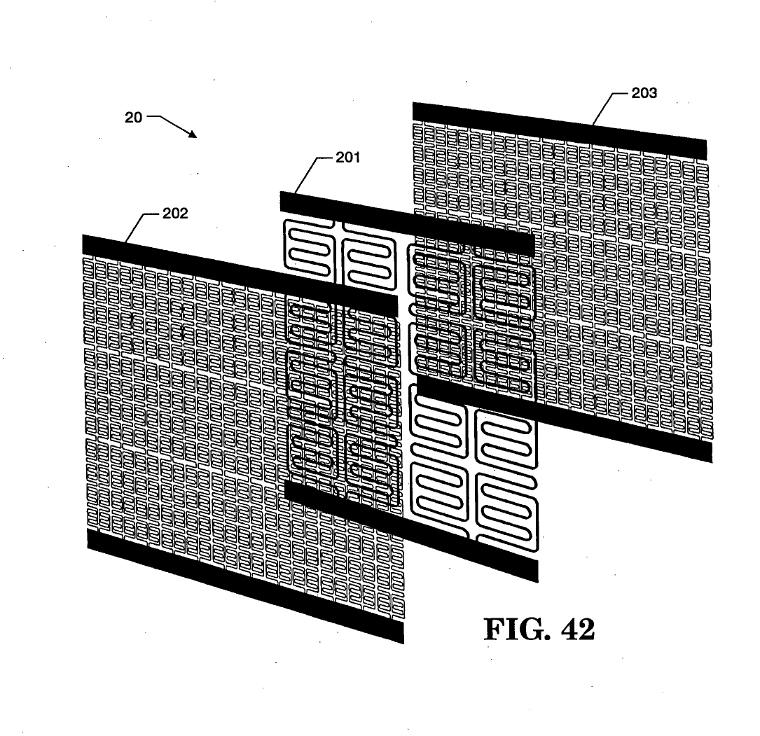

The selected geometry is then modeled using a Computer Aided Design (CAD) system, as illustrated in FIG. 41 and FIG. 42, and carefully shaped to have symmetry so that large planar spring prototypes can be patterned from a small section. FIG. 41 shows components of one embodiment 10 of a composite skin, comprising a planar spring 101 designed for flexibility in one axis, and sandwiched between elastomeric sheet 102 and elastomeric sheet 103. Similarly, FIG. 42 shows one embodiment 20 of the present invention, having a planar spring 201 designed for flexibility in two directions, and sandwiched between elastomeric sheet 202 and elastomeric sheet 203. A representative small section of the planar spring is computationally analyzed using a modern Finite Element Analysis program to determine flexibility and maximum stress. An iterative design process is used to optimize a shape to give the most flexibility at the least stress, without violating fabrication limitations of the material. Typical design targets for some selected embodiments of the invention are 15%-global elongation with a safety factor of 2 on yield strength. In-plane stiffness and out-of-plane bending stiffness are largely dependent on the global elongation criteria.

For a typical laminated structure having a thin surface spring coating combined with a thicker core spring structure, both elements may be independently analyzed to have similar global elongation properties. The contributions to the stiffness due to the elastomeric fill material and the joining of the independent elements are not analyzed in the initial design. This is more readily measured on sample prototype structures.

Typically 2024 or 7075 aluminum alloys, and cold-rolled stainless steel are used in the production of prototype skeletal planar springs. Preferably, but not necessarily, the skeleton material should have an ultimate tensile strength of at least 175,000 psi. The skeleton material is two-dimensionally cut to produce a planar spring, i.e. a bi-directional spring, using waterjet, laser, chemical etching, or other suitable rapid cutting process. The purpose of the produced planar spring or bi-directional spring is to provide through-plane stiffness to prevent drumming type movement normal to the surface, while allowing flexibility in the planar (bi-directional) dimension.

The skeletal spring is then embedded in a castable, elastomeric material to provide a smooth composite skin. Materials used in prototype fabrication include latex and silicone. A number of suitable materials, including an acrylic synthetic latex rubber, a water-based neoprene modified natural latex, and a single component self-curing synthetic liquid rubber are available from a manufacturer called Zeller International, of Downsville N.Y. Zeller International can be reached by telephone at (607) 363-7792, and their products can be viewed at htt://www.zeller-int.com/.

Elastomeric materials may be cast with the skeleton embedded within the casting, or the elastomer may be sprayed, dipped or brushed on. Typically, elastomers are used which have sufficient adhesive properties to allow brushing or spraying to be performed in layers without resulting in a laminated skin; i.e. the resulting elastomeric component of the skin is substantially monolithic.

In addition to this relatively simple monolithic structure, however, one embodiment of the present invention enhances the performance of the skin by layering or sandwiching the various components. Particularly for highly curved shapes such as the leading edge of a wing, the shape can be generated by laminating several sheets of thin planar springs using the elastomer as the binder to hold the sheets together. For high performance panels with higher out-of-plane stiffness and low drive force at minimum weight, a sandwich type construction can be used with a thin, relatively stiffer material as the face (outer) spring sheet and a softer spring sheet as the core (inner) layer.

Skin stiffness is tailored by varying the material, thickness, cut shape, and local beam thickness of the internal skeleton. The internal skeleton can be designed to be less stiff in one planar direction or approximately the same stiffness in both planar directions. The former can be advantageous for 2-D hinge type applications. The latter is typically desired for more 3-D applications, such as platform changes or bump modification. Stiffness is further tailored by varying the elasticity of the elastomeric filler. Hardpoints for actuator or constraint attachments can be easily incorporated by including a threaded attachment location within the internal skeleton.

Global strain rate of the composite structure may exceed 20% in-plane, as shown in the data provided in Table 1 at the end of this written description. Table 1 provides a compilation of prototype stress and strain properties derived from finite element analysis of various embodiments of the present invention, to assist in the mechanical definition of the composite structure. “In-plane” and “planar” in the context of this description are to be understood to mean “bi-directional,” or within one or two dimensions. Although the present invention may be fabricated and used in a planar configuration, it should be well understood that typical utilization of the invention would occur in three-dimensional applications, for example in aircraft wing skins or boat hulls.

Although the current embodiment of the present invention utilizes planar springs etched or cut from single monolithic sheets of metal, fabrication methods for the internal skeletal framework may include welding, brazing, bonding, or otherwise permanently joining formed strip or wire to create the desired planar spring shape. Particularly for non-metallic reinforcement, casting or injection molding methods may also be used to create the skeleton.

An additional method of construction for one embodiment of the invention utilizes a commercially made elastomeric sheet material bonded to the skeletal framework, with or without filling the core skeleton with elastomer (see again FIGS. 41-42). In addition, a sandwich construction method may use a stiffer, thin, elastomer-filled planar spring face sheet, bonded to a thicker core planar spring with elastomer, with or without filling the core skeleton.

Additional means of attaching the flexible skin to underlying structure include bonding to the skin assembly at node points or node lines using the elastomer as the bond agent or other compatible adhesive. Mechanical attachment points may be included in the internal skeleton as mentioned earlier, or by attaching a separate fastener hard point by means of adhesion, bonding, brazing, welding, or other suitable method. Hard points provide the attachment interface to the underlying structure by bonding, screwing, riveting, or other means.

The stiffness of the internal skeleton may be tailored to provide highly directional flexibility or nearly uniform flexibility in all directions. With proper design shaping, the relative flexibility among the different directions can be varied anywhere between these two extremes. The degree of flexibility can be varied by the methods stated above. Some commercially available elastomers can be used to vary the stiffness by varying the chemical composition within the built up structure. These can be applied in thin layers by brushing, spraying, dipping or pouring. Multiple layers can be built up in this fashion, with each additional layer permanently fusing with the previous layer. In this way the stiffness of the structure can be varied through the thickness and/or throughout the area of the skin structure.

The composite structure is designed to be loaded in a tensile manner from a natural, unconstrained state of elongation. To achieve compressive loading (negative elongation), the structure can be designed such that the skin is partially elongated to mate with the underlying structure in a neutral position (at some point between maximum compression and maximum extension). In this way the skin will be in its unconstrained position when the underlying structure is in its most compressed state. In a somewhat similar way, the elastomer may be mated with the skeletal material when the skeleton is pre-compressed. This serves to increase the allowable elongation in the skin structure by using both the compressive and tensile elastic strain of the skeletal material.

One embodiment of the present invention includes embedding electronic devices by using the planar spring sheet as a carrier for a flexible printed circuit board. This enables controls, MEMS sensors, and other instrumentation to be integral with the skin and provide a convenient means to interface to external sources. Another embodiment includes piezoelectric elements embedded within the flexible skin, or attached to the flexible skin or its skeleton. The piezoelectric elements can be used as actuators to drive the deflection of the flexible skin, or as sensors to provide measurement data in response to the skin's deflection.

This flexible skin is enabling technology for aircraft morphing applications. It provides a smooth aerodynamic covering that can flex and stretch with structural shape change. The composite skin assembly simultaneously maximizes in-plane flexibility and out-of-plane stiffness. Other applications that require large recoverable shape change can also benefit from this technology.

It is foreseen that this technology will have application in many aircraft morphing configurations. By varying the geometry, material properties, and construction methods, it may be tailored for use in wind-tunnel models, Unmanned Aerial Vehicles (UAV), and manned aircraft. It should also have application in many other transportation areas such as automotive, trucks, buses, where fuel savings can be made with improved aerodynamics. Some potential aircraft applications include aircraft wing bumps (for shock suppression), variable wing shapes, conformable control surfaces, variable nozzles, and variable engine intakes. Other applications include adaptable vehicle safety systems (e.g. impact recoverable bumpers), impact resistant skins (e.g. self healing materials), bladders, flexible/variable ducting, and conformal control surfaces for ships and submarines.

Although the invention has been described relative to a few specific embodiments, there are numerous variations and modifications that will be readily apparent to those skilled in the art, in light of the above teachings. It is therefore to be understood that, within the scope of the appended claims, the invention may be practiced other than as specifically described.

TABLE 1

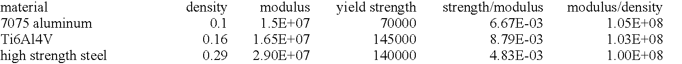

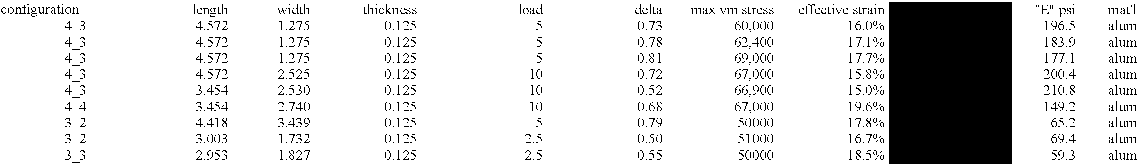

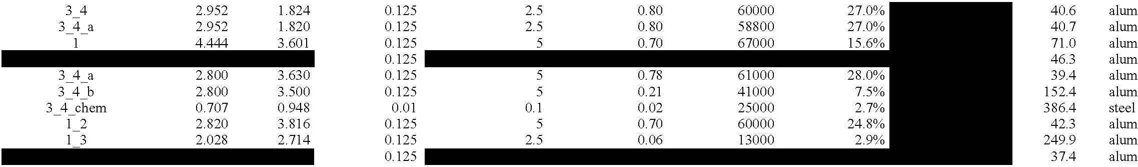

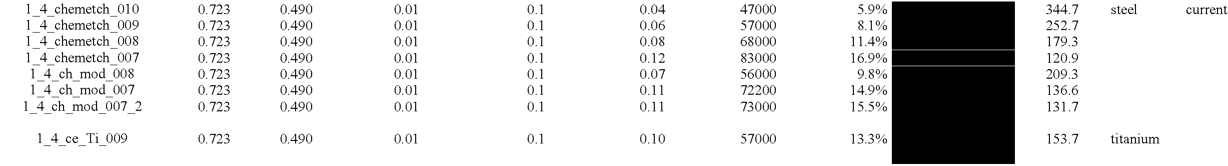

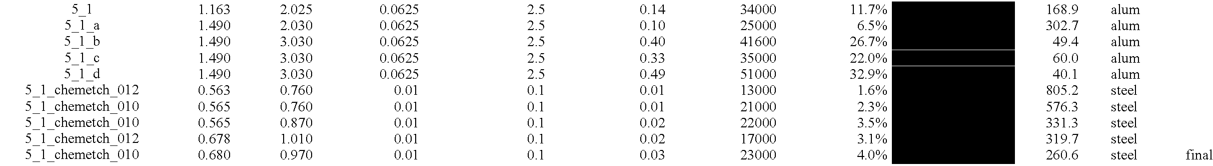

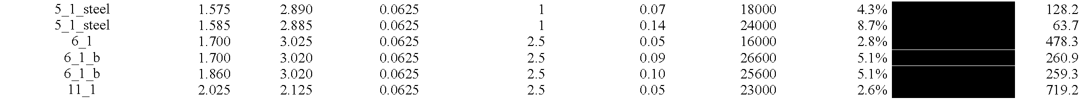

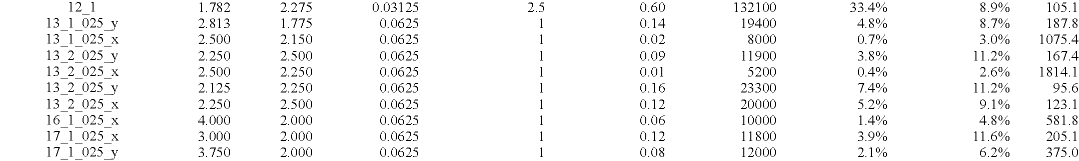

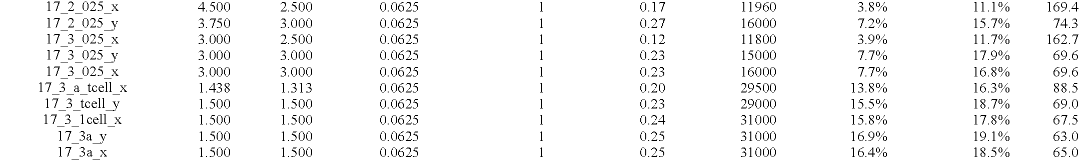

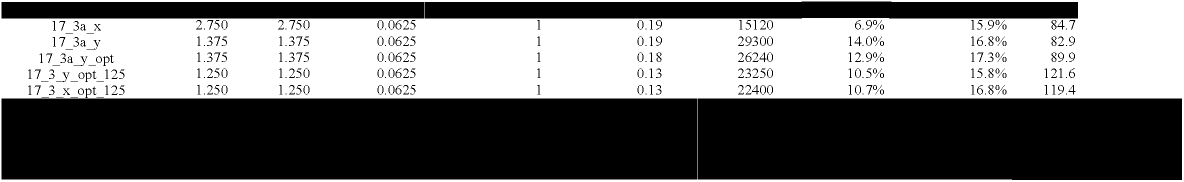

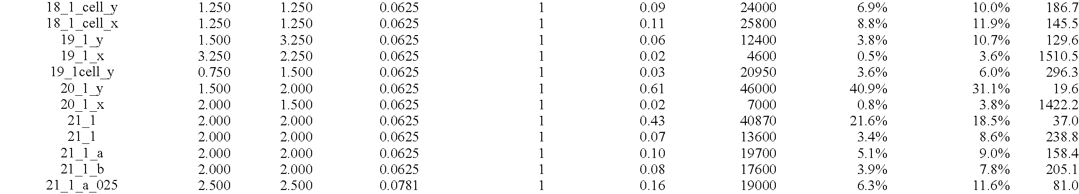

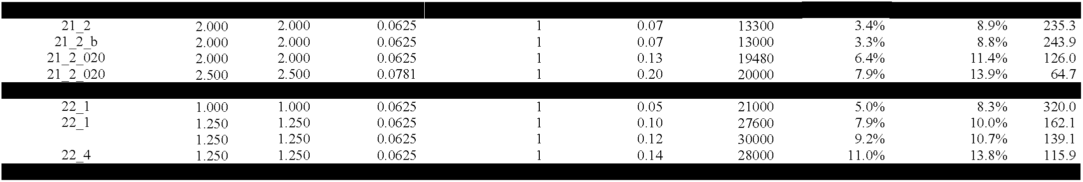

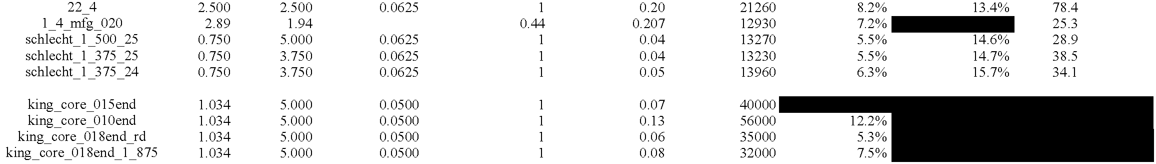

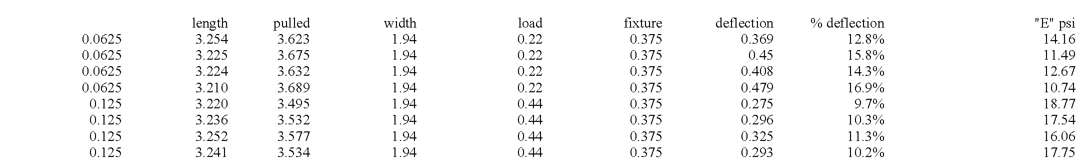

1. A flexible skin, comprising:
a bidirectional spring, encapsulated within a flexible solid.

2. A flexible skin according to claim 1, wherein the flexible solid is an elastomeric material.

3. A flexible skin according to claim 2, wherein the elastomeric material is rolled.

4. A flexible skin according to claim 2, wherein the elastomeric material is cast.

5. A flexible skin according to claim 2, wherein the elastomeric material is poured.

6. A flexible skin according to claim 2, wherein the elastomeric material is sprayed.

7. A flexible skin according to claim 2, wherein the elastomeric material is dipped.

8. A flexible skin according to claim 1, wherein the bidirectional spring has flexural properties that vary between the two axes.

9. A flexible skin according to claim 1, wherein flexible printed circuitry is carried by the bi-directional spring.

10. A flexible skin according to claim 1, further comprising:
a second bidirectional spring, encapsulated within a second flexible solid,
the second flexible solid being adhered in a layered manner to the flexible solid.

11. A flexible skin, comprising:
a bi-directional spring, skeletally attached to a flexible membrane.

12. A flexible skin according to claim 11, wherein the flexible membrane attaches to one side of the bi-directional spring.

13. A flexible skin according to claim 11, wherein the flexible membrane attaches to both sides of the bi-directional spring.

14. A method for fabricating a flexible skin, comprising the steps of:
producing a bi-directional spring, and
embedding the bi-directional spring in a flexible solid.

15. A method for fabricating a flexible skin according to claim 14, wherein the bi-directional spring is produced by chemically etching a sheet of material.

16. A method for fabricating a flexible skin according to claim 14, wherein the bidirectional spring is produced by cutting a pattern from a sheet of material, using a rapid cutting process.

17. A method for fabricating a flexible skin according to claim 16, wherein the rapid cutting process is a laser cutting process.

18. A method for fabricating a flexible skin according to claim 16, wherein the rapid cutting process is a waterjet cutting process.

19. A method for fabricating a flexible skin according to claim 14, wherein the bi-directional spring is produced from a metallic material.

20. A method for fabricating a flexible skin according to claim 14, wherein the bi-directional spring is produced from a plastic composite material.

21. A method for fabricating a flexible skin according to claim 14, wherein the bi-directional spring is embedded in the flexible solid by dipping the bi-directional spring in an uncured elastomer and then curing the elastomer.

22. A method for fabricating a flexible skin according to claim 14, wherein the bi-directional spring is embedded in the flexible solid by spraying elastomeric material over the bi-directional spring.

23. A method for fabricating a flexible skin according to claim 14, wherein the bi-directional spring is embedded in the flexible solid by pouring elastomeric material over the bi-directional spring.

24. A method for fabricating a flexible skin according to claim 14, wherein the bi-directional spring is embedded in the flexible solid by brushing elastomeric material over the bi-directional spring.

25. A method for fabricating a flexible skin, comprising the steps of:
producing a bi-directional spring, and
adhering a flexible membrane to a surface of the bi-directional spring.

26. A method for fabricating a flexible skin, comprising the steps of:
producing a bi-directional spring, and adhering a flexible membrane to each surface of the bi-directional spring.

27. A method for fabricating a flexible skin according to claim 25, further comprising the step of adhering a second flexible skin to the flexible skin.

28. A method for fabricating a flexible skin according to claim 14, further comprising the step of adhering a second flexible skin to the flexible skin.

29. A flexible skin according to claim 1, further comprising a piezoelectric element embedded within the flexible solid.

30. A flexible skin according to claim 11, further comprising a piezoelectric element bonded to a surface of the bi-directional spring.

31. A flexible skin according to claim 11, further comprising a piezoelectric element bonded to the flexible membrane.

32. A method for fabricating a flexible skin according to claim 25, further comprising the step of bonding a piezoelectric element to a surface of the bi-directional spring.

33. A method for fabricating a flexible skin according to claim 25, further comprising the step of bonding a piezoelectric element to the flexible membrane.

34. A method of fabricating a flexible skin according to claim 14, further comprising the step of embedding printed circuitry within the flexible solid.

35. A method for fabricating a flexible skin according to claim 25, further comprising the step of bonding printed circuitry to a surface of the bi-directional spring.

36. A method for fabricating a flexible skin according to claim 25, further comprising the step of bonding printed circuitry to the flexible membrane.
